(19) United States
(12) Patent Application Publication
(10) Pub. No.: US 2024/0308550 A1
(43) Pub. Date: Sep. 19, 2024

(54) METHOD FOR PREDICTING VEHICLE TRAJECTORY, CONTROL DEVICE, READABLE STORAGE MEDIUM, AND VEHICLE

(71) Applicant: Anhui NIO Autonomous Driving Technology Co., Ltd., Hefei (CN)

(72) Inventors: Qixiang PENG, Shanghai (CN); Haibo QIN, Shanghai (CN); Chuankang LI, Shanghai (CN); Bing WU, Shanghai (CN); Maoqing YAO, Shanghai (CN)

(21) Appl. No.: 18/411,352

(22) Filed: Jan. 12, 2024

(30) Foreign Application Priority Data
Mar. 15, 2023 (CN) 202310249549.3

(51) Int. Cl. B60W 60/00; B60W 50/00

(52) U.S. Cl. CPC B60W 60/0027; B60W 50/0097; B60W 2554/404; B60W 2556/35

(57) ABSTRACT

A method for predicting a vehicle trajectory, a control device, a readable storage medium, and a vehicle are proved to solve the problem of effectively predicting a multimodal trajectory of a vehicle. According to the disclosure, perceived information of an autonomous vehicle is converted into vectorized features of target vehicles, where the target vehicles include the autonomous vehicle and a plurality of first surrounding vehicles; and trajectory prediction results of the target vehicles are obtained based on the vectorized features. The vectorized features in the disclosure are obtained based on the perceived information of the autonomous vehicle, which enables the vectorized features to include rich vehicle trajectory information and environment information of the target vehicle; and interaction and fusion are performed on the vectorized features of the target vehicle, so that a plurality of vehicle trajectories of each target vehicle can be effectively predicted.

### CROSS-REFERENCE TO RELATED APPLICATION

This application claims the benefit of and priority to Chinese Patent Application No. 202310249549.3 filed on Mar. 15, 2023, the entire disclosure of which is hereby incorporated herein by reference, in its entirety, for all that it teaches and for all purposes.

### TECHNICAL FIELD

The disclosure relates to the technical field of autonomous driving, and specifically provides a method for predicting a vehicle trajectory, a control device, a readable storage medium, and a vehicle.

### BACKGROUND

The functions of advanced driver assistance technology are increasingly recognized by users. At the same time, its application scenarios are continuously expanding with the advancement of sensors and information, and its functional experience is also continuously improving. For trajectory prediction, a key issue is how to provide a reasonable multimodal predicted trajectory to effectively assist an autonomous driving function.

A prediction method in the prior art is mainly rendering perceived information from a perception model into image features that are to be processed through a convolutional neural network for vehicle trajectory prediction. Due to a limited receptive field of the convolutional neural network, it is difficult to fully utilize and consider interaction between a surrounding environment and a self-vehicle as well as surrounding vehicles.

Accordingly, there is a need for a new solution for predicting a vehicle trajectory in the art to solve the above problem.

### BRIEF SUMMARY

In order to overcome the above defect, the disclosure is proposed to solve or at least partially solve the problem of how to effectively predict a multimodal trajectory of a vehicle.

According to a first aspect, the disclosure provides a method for predicting a vehicle trajectory. The method includes:
obtaining vectorized features of a plurality of target vehicles based on perceived information of an autonomous vehicle; and
obtaining a trajectory prediction result based on vectorized features of each of the target vehicles, to obtain a plurality of trajectory prediction results of the plurality of target vehicles; wherein
the plurality of target vehicles include the autonomous vehicle and a plurality of first surrounding vehicles, wherein the plurality of first surrounding vehicles being vehicles in a surrounding environment of the autonomous vehicle that are selected according to a preset first rule; and
the perceived information is obtained based on data acquired by a sensor of the autonomous vehicle.

In a technical solution of the foregoing method for predicting a vehicle trajectory, the obtaining vectorized features of a plurality of target vehicles further includes:
obtaining based on the perceived information of the autonomous vehicle, self-vehicle trajectory vectorized features, surrounding trajectory vectorized features, and road network vectorized features of each of the target vehicles; wherein
the surrounding trajectory vectorized features are trajectory vectorized features of a plurality of second surrounding vehicles of the target vehicle, the plurality of second surrounding vehicles being vehicles in a surrounding environment of the target vehicle that are selected according to a preset second rule.

In a technical solution of the foregoing method for predicting a vehicle trajectory, the obtaining a trajectory prediction result based on vectorized features of each of the target vehicles further includes:
obtaining for each of the target vehicles, encoded features of the target vehicle based on the self-vehicle trajectory vectorized features, the surrounding trajectory vectorized features, and the road network vectorized features of the target vehicle; and
obtaining the trajectory prediction result of the target vehicle based on the encoded features of the target vehicle.

In a technical solution of the foregoing method for predicting a vehicle trajectory, the obtaining encoded features of the target vehicle based on the self-vehicle trajectory vectorized features, the surrounding trajectory vectorized features, and the road network vectorized features of the target vehicle further includes:
encoding the self-vehicle trajectory vectorized features, the surrounding trajectory vectorized features, and the road network vectorized features to obtain self-vehicle trajectory encoded features, surrounding trajectory encoded features, and road network encoded features, respectively;
performing feature interaction on the self-vehicle trajectory encoded features, the surrounding trajectory encoded features, and the road network encoded features to obtain self-vehicle trajectory interaction features, surrounding trajectory interaction features, and environment interaction features, respectively; and
performing feature fusion on the self-vehicle trajectory interaction features, the surrounding trajectory interaction features, and the environment interaction features to obtain the encoded features of the target vehicle.

In a technical solution of the foregoing method for predicting a vehicle trajectory, the performing feature interaction on the self-vehicle trajectory encoded features, the surrounding trajectory encoded features, and the road network encoded features further includes:
using for the self-vehicle trajectory encoded features, an all-ones vector as environment information for feature interaction to obtain the self-vehicle trajectory interaction features;
using for the surrounding trajectory encoded features, the self-vehicle trajectory encoded features as environment information for feature interaction to obtain the surrounding trajectory interaction features; and
for the road network encoded features, using fusion features of the self-vehicle trajectory interaction features and the surrounding trajectory interaction features as environment information for feature interaction to obtain the road network interaction features.

In a technical solution of the foregoing method for predicting a vehicle trajectory, the method for predicting a vehicle trajectory further includes obtaining the fusion features of the self-vehicle trajectory interaction features and the surrounding trajectory interaction features according to the step of:
performing feature fusion on the self-vehicle trajectory interaction features and the surrounding trajectory interaction features to obtain the fusion features.

In a technical solution of the foregoing method for predicting a vehicle trajectory, the obtaining the trajectory prediction result of the target vehicle based on the encoded features of the target vehicle includes:
using pre-learned anchor features as environment information, and obtaining multimodal features of the target vehicle based on the encoded features of the target vehicle; and
obtaining the trajectory prediction result of the target vehicle based on the multimodal features.

In a technical solution of the foregoing method for predicting a vehicle trajectory, the obtaining vectorized features of a plurality of target vehicles based on perceived information of an autonomous vehicle includes:
for each target vehicle, structuring the perceived information to obtain structured data of the target vehicle; and
adding semantic information to the structured data to obtain vectorized features of the target vehicle.

In a technical solution of the foregoing method for predicting a vehicle trajectory, for each target vehicle, as well as a vehicle trajectory of the target vehicle and vehicle trajectories of the plurality of second surrounding vehicles of the target vehicle in the perceived information, the structuring the perceived information includes:
performing sequential processing on the vehicle trajectory of the target vehicle and the vehicle trajectory of each of the second surrounding vehicles to obtain sequential data including a historical frame and a current frame of a preset length; and
converting the sequential data into a coordinate system with a current frame position of the target vehicle as an origin so that the sequential data is used as the structured data of the target vehicle.

In a technical solution of the foregoing method for predicting a vehicle trajectory, for each target vehicle, as well as road network information of a surrounding road network of the target vehicle in the perceived information, the structuring the perceived information includes:
segmenting a lane line in the road network information according to a preset distance to obtain a plurality of lane line segments;
converting endpoint coordinates of the lane line segments to the coordinate system with the current frame position of the target vehicle as the origin;
for the lane line segments in the coordinate system with the current frame position of the target vehicle as the origin, selecting from the lane line segments according to a preset third rule; and using endpoint coordinates of the selected lane line segments as the structured data of the target vehicle.

According to a second aspect, a control device is provided. The control device includes at least one processor and at least one storage apparatus storing a plurality of program codes, where the program codes are adapted to be loaded and executed by the processor to perform the method for predicting a vehicle trajectory according to any one of the technical solutions of the foregoing method for predicting a vehicle trajectory.

According to a third aspect, a computer-readable storage medium is provided. The computer-readable storage medium has a plurality of program codes stored therein, where the program codes are adapted to be loaded and executed by a processor to perform the method for predicting a vehicle trajectory according to any one of the technical solutions of the foregoing method for predicting a vehicle trajectory.

According to a fourth aspect, a vehicle is provided. The vehicle includes the control device in the technical solution of the foregoing control device.

The above one or more technical solutions of the disclosure have at least one or more of the following beneficial effects:

In the technical solutions for implementing the disclosure, according to the disclosure, perceived information of an autonomous vehicle is converted into vectorized features of a plurality of target vehicles, where the target vehicles include the autonomous vehicle and a plurality of first surrounding vehicles; and a plurality of trajectory prediction results of the plurality of target vehicles are obtained based on vectorized features of each target vehicle. Through the above configuration, the vectorized features in the disclosure are obtained based on the perceived information of the autonomous vehicle, which enables the vectorized features to include rich vehicle trajectory information and environment information of the target vehicle; and full interaction and fusion are performed based on the vectorized features of each target vehicle, so that a plurality of vehicle trajectories of each target vehicle can be effectively predicted to obtain a more reasonable multimodal trajectory prediction result of each target vehicle. This allows the autonomous vehicle itself to assist an autonomous driving function based on the trajectory prediction result of the target vehicle to achieve more accurate and reasonable autonomous driving control, effectively improving the user experience.

### BRIEF DESCRIPTION OF THE SEVERAL VIEWS OF THE DRAWINGS

The disclosed content of the disclosure will become more readily understood with reference to the accompanying drawings. Those skilled in the art readily understand that these accompanying drawings are merely for illustrative purposes and are not intended to limit the scope of protection of the disclosure. In the drawings:

FIG. 1 is a schematic flowchart of main steps of a method for predicting a vehicle trajectory according to an embodiment of the disclosure;

FIG. 2 is a schematic flowchart of main steps of obtaining self-vehicle trajectory vectorized features and surrounding trajectory vectorized features of a target vehicle according to an implementation of an embodiment of the disclosure;

FIG. 3 is a schematic flowchart of main steps of obtaining road network vectorized features of a target vehicle according to an implementation of an embodiment of the disclosure;

FIG. 4 is a schematic diagram of main components of an encoder module according to an implementation of an embodiment of the disclosure;

FIG. 5 is a schematic diagram of main components of a decoder module according to an implementation of an embodiment of the disclosure; and

FIG. 6 is a schematic diagram of a trajectory prediction result of a target vehicle output by an encoder-decoder network model according to an example of an embodiment of the disclosure.

### DETAILED DESCRIPTION

Some implementations of the disclosure are described below with reference to the accompanying drawings. Those skilled in the art should understand that these implementations are only used to explain the technical principles of the disclosure, and are not intended to limit the scope of protection of the disclosure.

In the description of the disclosure, a “module” or “processor” may include hardware, software, or a combination thereof. A module may include a hardware circuit, various suitable sensors, a communication port, and a memory, or may include a software part, for example, program code, or may be a combination of software and hardware. The processor may be a central processing unit, a microprocessor, a graphics processing unit, a digital signal processor, or any other suitable processor. The processor has a data and/or signal processing function. The processor may be implemented in software, hardware, or a combination thereof. A non-transitory computer-readable storage medium includes any suitable medium that may store program codes, for example, a magnetic disk, a hard disk, an optical disc, a flash memory, a read-only memory, or a random access memory. The term “A and/or B” indicates all possible combinations of A and B, for example, only A, only B, or A and B. The term “at least one of A or B” or “at least one of A and B” has a meaning similar to “A and/or B” and may include only A, only B, or A and B. The terms “a/an” and “this” in the singular form may also include the plural form.

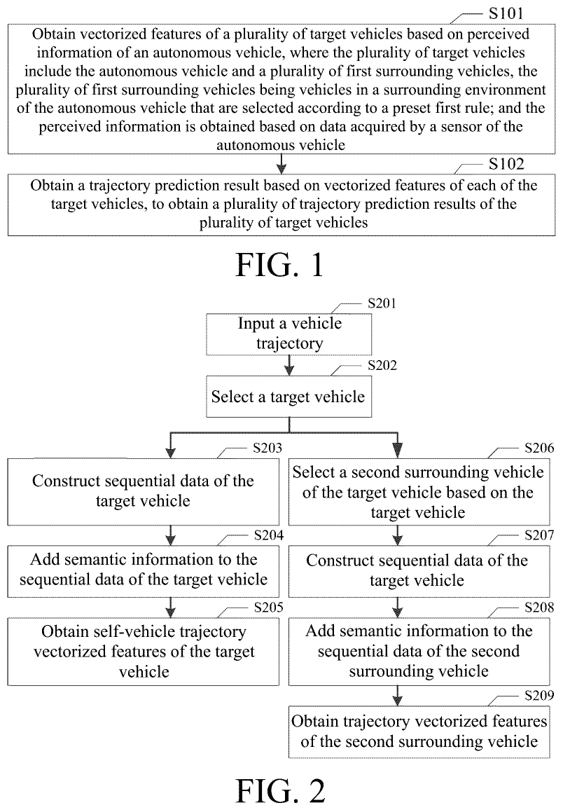

Referring to FIG. 1, FIG. 1 is a schematic flowchart of main steps of a method for predicting a vehicle trajectory according to an embodiment of the disclosure. As shown in FIG. 1, the method for predicting a vehicle trajectory in this embodiment of the disclosure mainly includes step S101 and step S102 as follows.

Step S101: Obtain vectorized features of a plurality of target vehicles based on perceived information of an autonomous vehicle, where the plurality of target vehicles include the autonomous vehicle and a plurality of first surrounding vehicles, the plurality of first surrounding vehicles being vehicles in a surrounding environment of the autonomous vehicle that are selected according to a preset first rule; and the perceived information is obtained based on data acquired by a sensor of the autonomous vehicle.

In this embodiment, the perceived information of the autonomous vehicle may be converted into the vectorized features of the plurality of target vehicles. The target vehicles may include the autonomous vehicle (i.e., the self-vehicle) and a plurality of first surrounding vehicles. The plurality of first surrounding vehicles are vehicles in the surrounding environment of the autonomous vehicle that are selected according to the preset first rule.

In an implementation, the data acquired by the sensor of the autonomous vehicle can be input into a perception model. The perception model can obtain, based on the data acquired by the sensor, the perceived information of the autonomous vehicle, such as its own vehicle trajectory, vehicle trajectories of the vehicles in the surrounding environment, and road network information in the surrounding environment.

In an implementation, the first rule may be a first preset number of vehicles closest to the autonomous vehicle (the self-vehicle). For example, the first preset number may be 24. Those skilled in the art may set the first rule and the first preset number according to requirements of a practical application. Those skilled in the art can understand that the vehicles determined by the first rule may include all vehicles in the surrounding environment that can be acquired by the self-vehicle through the sensor.

In an implementation, step S101 may further include: based on the perceived information of the autonomous vehicle, obtaining self-vehicle trajectory vectorized features, surrounding trajectory vectorized features, and road network vectorized features of each of the target vehicles, where the surrounding trajectory vectorized features are trajectory vectorized features of a plurality of second surrounding vehicles of the target vehicle, the plurality of second surrounding vehicles being vehicles in a surrounding environment of the target vehicle that are selected according to a preset second rule.

In an implementation, the second rule may be a second preset number of vehicles closest to the target vehicle. For example, the second preset number may be 32. Those skilled in the art may set the second rule and the second preset number according to requirements of a practical application. Those skilled in the art can understand that the vehicles determined by the second rule may include all vehicles, other than the current target vehicles, in the surrounding environment that are acquired by the self-vehicle through the sensor.

Step S102: Obtain a trajectory prediction result based on vectorized features of each of the target vehicles, to obtain a plurality of trajectory prediction results of the plurality of target vehicles.

In this embodiment, a trajectory prediction result of each target vehicle may be obtained based on vectorized features of the target vehicle.

In an implementation, the vectorized features of each target vehicle can be input into an encoder-decoder network model, and a trajectory of each target vehicle can be predicted based on the vectorized features of the target vehicle to obtain the trajectory prediction result. Encoder-decoder is a model framework in deep learning, which uses an end-to-end algorithm to convert the input vectorized features into a fixed-length vector (encoding), and convert the fixed-length vector into an output sequence (decoding).

In an implementation, the encoder-decoder network model may include an encoder module and a decoder module.

In an implementation, the self-vehicle trajectory vectorized features, the surrounding trajectory vectorized features, and the road network vectorized features of the target vehicle can be input into the encoder module to obtain encoded features of the target vehicle, and then the encoded features are input into the decoder module to obtain the trajectory prediction result of the target vehicle.

Based on step S101 and step S102 described above, according to this embodiment of the disclosure, perceived information of an autonomous vehicle is converted into vectorized features of a plurality of target vehicles, where the target vehicles include the autonomous vehicle and a plurality of first surrounding vehicles; and a plurality of trajectory prediction results of the plurality of target vehicles are obtained based on vectorized features of each target vehicle. Through the above configuration, the vectorized features in this embodiment of the disclosure are obtained based on the perceived information of the autonomous vehicle, which enables the vectorized features to include rich vehicle trajectory information and environment information of the target vehicle; and full interaction and fusion are performed based on the vectorized features of each target vehicle, so that a plurality of vehicle trajectories of each target vehicle can be effectively predicted to obtain a more reasonable multimodal trajectory prediction result of each target vehicle. This allows the autonomous vehicle itself to assist an autonomous driving function based on the trajectory prediction result of the target vehicle to achieve more accurate and reasonable autonomous driving control, effectively improving the user experience.

Step S101 and step S102 are further described below.

In an implementation of this embodiment of the disclosure, step S101 may further include step S1011 and S1012 as follows.

Step S1011: For each target vehicle, structure the perceived information to obtain structured data of the target vehicle.

In this implementation, the perceived information may be structured to obtain the structured data of the target vehicle.

In an implementation, the perceived information may include a vehicle trajectory of the target vehicle and vehicle trajectories of a plurality of second surrounding vehicles of the target vehicle. Structuring may include sequential processing. Step S1011 may further include step S10111 and step S10112 as follows.

Step S10111: Perform sequential processing on the vehicle trajectory of the target vehicle and the vehicle trajectory of each of the second surrounding vehicles to obtain sequential data including a historical frame and a current frame of a preset length.

Step S10112: Convert the sequential data into a coordinate system with a current frame position of the target vehicle as an origin so that the sequential data is used as the structured data of the target vehicle.

In this implementation, the sequential processing may be first performed on the vehicle trajectory of the target vehicle and the vehicle trajectory of each of the second surrounding vehicles to obtain the sequential data including the historical frame and the current frames of the preset length. The sequential data may be then converted to the coordinate system with the current frame position of the target vehicle as the origin to obtain the structured data of the target vehicle.

In an implementation, the perceived information may include road network information of a surrounding road network of the target vehicle. Structuring may include segmentation. Step S1011 may further include step S10113 and step S10115 as follows.

Step S10113: Segment a lane line in the road network information according to a preset distance to obtain a plurality of lane line segments.

Step S10114: Convert endpoint coordinates of the lane line segments to the coordinate system with the current frame position of the target vehicle as the origin.

Step S10115: For the lane line segments in the coordinate system with the current frame position of the target vehicle as the origin, select from the lane line segments according to a preset third rule; and use endpoint coordinates of the selected lane line segments as the structured data of the target vehicle.

In this implementation, the lane line in the road network information may be segmented at equal distances to obtain a plurality of lane line segments, and the endpoint coordinates of these lane line segments are converted to the coordinate system with the current frame position of the target vehicle as the origin. A range of the road network information is relatively wide (such as within a radius of one kilometer), while only road network information within a small range needs to be selected for trajectory prediction. Therefore, the lane line segments can be selected according to the third rule to obtain the structured data of the target vehicle. Those skilled in the art may set the preset distance and the third rule according to requirements of a practical application.

In an implementation, the preset distance may be 10 m.

In an implementation, the third rule may be to select lane line segments within a range of 200 m around the target vehicle.

Step S1012: Add semantic information to the structured data to obtain vectorized features of the target vehicle.

In this implementation, the semantic information may be added to the structured data of the target vehicle to obtain the vectorized features. Semantic features of the vehicle trajectory may include a speed, size, type, and other information of the target vehicle. Semantic features of the road network information may include: a shortest distance between the lane line segment and the target vehicle; a unit vector pointing from the target vehicle to a nearest point; a unit vector of the lane line segment; a unit vector pointing from a start point of the lane line segment to an end point of the lane line segment; a length of the lane line segment; a length from the end point of the lane line segment to the nearest point; a lane line type of the lane line segment, etc. The addition of the semantic information can make the vectorized features have richer information, making it easier to predict a vehicle trajectory based on the vectorized features. It should be noted that only part of the semantic information is listed here, and those skilled in the art can add or delete the semantic information according to requirements of a practical application, which are all within the scope of protection of the disclosure.

In an implementation of this embodiment of the disclosure, step S102 may further include step S1021 and step S1022 as follows.

Step S1021: For each of the target vehicles, obtain encoded features of the target vehicle based on the self-vehicle trajectory vectorized features, the surrounding trajectory vectorized features, and the road network vectorized features of the target vehicle.

In this implementation, step S1021 may further include step S10211 to step S10213 as follows.

Step S10211: Encode the self-vehicle trajectory vectorized features, the surrounding trajectory vectorized features, and the road network vectorized features to obtain self-vehicle trajectory encoded features, surrounding trajectory encoded features, and road network encoded features, respectively.

In an implementation, the encoder module in the encoder-decoder network model may be used to encode the self-vehicle trajectory vectorized features, the surrounding trajectory vectorized features, and the road network vectorized features.

Step S10212: Perform feature interaction on the self-vehicle trajectory encoded features, the surrounding trajectory encoded features, and the road network encoded features to obtain self-vehicle trajectory interaction features, surrounding trajectory interaction features, and environment interaction features, respectively.

In this implementation, step S10212 may further include step S102121 to step S102123 as follows.

Step S102121: For the self-vehicle trajectory encoded features, use an all-ones vector as environment information for feature interaction to obtain the self-vehicle trajectory interaction features.

Step S102122: For the surrounding trajectory encoded features, use the self-vehicle trajectory encoded features as environment information for feature interaction to obtain the surrounding trajectory interaction features.

Step S102123: For the road network encoded features, use fusion features of the self-vehicle trajectory interaction features and the surrounding trajectory interaction features as environment information for feature interaction to obtain the road network interaction features.

In this implementation, feature fusion may be performed on the self-vehicle trajectory interaction features and the surrounding trajectory interaction features to obtain fusion features.

Step S10213: Perform feature fusion on the self-vehicle trajectory interaction features, the surrounding trajectory interaction features, and the environment interaction features to obtain the encoded features of the target vehicle.

In this implementation, the feature fusion may be performed on the self-vehicle trajectory interaction features, the surrounding trajectory interaction features, and the road network interaction features to obtain the encoded features of the target vehicle.

In an implementation, reference may be made to FIG. 4. FIG. 4 is a schematic diagram of main components of an encoder module according to an implementation of an embodiment of the disclosure. As shown in FIG. 4, the encoder module may include a target vehicle encoder submodule, a surrounding vehicle encoder submodule, a road network encoder submodule, an attention submodule, and a feature fusion submodule. The target vehicle encoder submodule in FIG. 4 may be used to learn sequential information of the self-vehicle trajectory vectorized features of the target vehicle, the surrounding vehicle encoder submodule may be used to learn sequential information of the surrounding trajectory vectorized features of the second surrounding vehicle, and the road network encoder submodule may be used to encode the semantic information in the road network. The target vehicle encoder submodule and the surrounding vehicle encoder submodule can be composed of a long short-term memory network (LSTM), and the road network encoder submodule can be composed of a fully connected network such as a multilayer perceptron (MLP).

In an implementation, the encoder attention submodule may be used to perform feature interaction on the self-vehicle trajectory encoded features of the target vehicle, the surrounding trajectory encoded features of the second surrounding vehicle, and the road network encoded features, thereby obtaining interaction features. The attention submodule can be used to solve the problem of information loss due to too long information during an encoding-decoding process.

The encoder attention submodule may include a target vehicle attention unit, a surrounding vehicle attention unit, and a road network attention unit. As shown in FIG. 4, the target vehicle attention unit uses the self-vehicle trajectory encoded features of the target vehicle as target information. Since the self-vehicle trajectory encoded features have no environment information (context), an all-ones vector may be input as environment information for feature interaction, and the target vehicle attention unit continue to learn the sequential information of the target vehicle, thereby obtaining the self-vehicle trajectory interaction features. The surrounding vehicle attention unit uses the self-vehicle trajectory encoded features of the target vehicle as environment information, and the surrounding trajectory encoded features of the second surrounding vehicle as target information for feature interaction, and learns interaction features of the target vehicle and the second surrounding vehicle, thereby obtaining the surrounding trajectory interaction features. The road network attention unit uses the fusion features of the self-vehicle trajectory interaction features and the surrounding trajectory interaction as environment information, and the road network encoded features as target information for feature interaction to obtain the road network interaction features of the surrounding road network.

In an implementation, as shown in FIG. 4, the feature fusion may be performed on the self-vehicle trajectory interaction features and the surrounding trajectory interaction features to obtain the fusion features. For example, the self-vehicle trajectory interaction features and the surrounding trajectory interaction features are input into the fully connected network for feature fusion, and an output of the fully connected network is used as the fusion features of the self-vehicle trajectory interaction features and the surrounding trajectory interaction features.

In an implementation, the target vehicle attention unit, the surrounding vehicle attention unit, and the road network attention unit each are composed of a fully connected network such as a multilayer perceptron (MLP) and a residual structure.

In an implementation, as shown in FIG. 4, the feature fusion submodule may be used to deeply fuse the self-vehicle trajectory interaction features, the surrounding trajectory interaction features, and the road network interaction features to obtain the encoded features of the target vehicle.

Step S1022: Obtain the trajectory prediction result of the target vehicle based on the encoded features of the target vehicle.

In this implementation, the trajectory prediction result of each target vehicle may be obtained based on the encoded features of the target vehicle.

In an implementation, the encoded features of the target vehicle may be input into the decoder module in the encoder-decoder network model to obtain the trajectory prediction result of the target vehicle.

Reference may be made to FIG. 5. FIG. 5 is a schematic diagram of main components of a decoder module according to an implementation of an embodiment of the disclosure. As shown in FIG. 5, the decoder module may include a decoder attention submodule and a fully connected submodule. Step S1022 may further include step S10221 and step S10222 as follows.

Step S10221: Use pre-learned anchor features as environment information, and obtain multimodal features of the target vehicle based on the encoded features of the target vehicle.

In this implementation, the pre-learned anchor features may be used as environment information, the encoded features of the target vehicle may be used as target information, and the multimodal features of the target vehicle may be obtained by the decoder attention submodule. The multimodal features are features that include a plurality of modalities, which can describe a future trajectory of the target vehicle from a plurality of perspectives. The anchor features (learnable parameters) are self-learned parameters, which are learned through neural network training by using training data. The anchor features are related to the trajectory prediction result of the target vehicle, and they can guide the decoder module to predict and obtain the trajectory prediction result.

In an implementation, a structure of the decoder attention submodule is the same as the structure of the target vehicle attention unit, the surrounding vehicle attention unit, and the road network attention unit in the encoder attention submodule.

Step S10222: Obtain the trajectory prediction result of the target vehicle based on the multimodal features.

In this implementation, the multimodal features may be input into the fully connected submodule to obtain a plurality of trajectory prediction results of each target vehicle within a specified time range in the future.

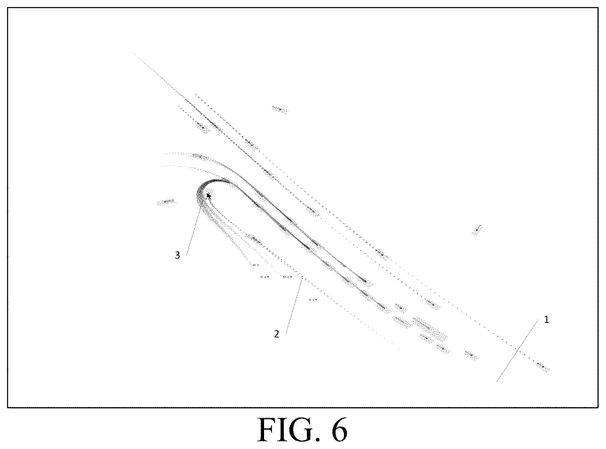

Reference may be made to FIG. 6. FIG. 6 is a schematic diagram of a trajectory prediction result of a target vehicle output by an encoder-decoder network model according to an example of an embodiment of the disclosure. As shown in FIG. 6, a rectangular box in FIG. 6 is the target vehicle. FIG. 6 shows road network information 1, an actual traveling trajectory 2 of the target vehicle, and a trajectory prediction result 3 of the target vehicle, where the color shade of the actual traveling trajectory and the trajectory prediction result represents the proximity in time. It can be seen from FIG. 6 that in an extremely difficult scenario where a vehicle makes a U-turn, a trajectory prediction result that is very close to an actual traveling trajectory can be predicted by using the vehicle trajectory prediction method according to this embodiment of the disclosure.

In an implementation, reference may be made to FIG. 2. FIG. 2 is a schematic flowchart of main steps of obtaining self-vehicle trajectory vectorized features and surrounding trajectory vectorized features of a target vehicle according to an implementation of an embodiment of the disclosure. As shown in FIG. 2, the self-vehicle trajectory vectorized features and the surrounding trajectory vectorized features of the target vehicle may be obtained through step S201 to step S209 as follows.

Step S201: Input a vehicle trajectory.

In this implementation, a vehicle trajectory obtained by a perception model may be input first.

Step S202: Select a target vehicle.

In this implementation, the target vehicle may be selected according to a first rule.

Step S203: Construct sequential data of the target vehicle.

In this implementation, a vehicle trajectory of the target vehicle may be subjected to sequential processing, and then converted to a coordinate system with a current frame position of the target vehicle as an origin, so as to obtain the sequential data of the target vehicle.

Step S204: Add semantic information to the sequential data of the target vehicle.

In this implementation, the semantic information may be added to the sequential data of the target vehicle.

Step S205: Obtain self-vehicle trajectory vectorized features of the target vehicle.

In this implementation, the sequential data with the semantic information added may be used as the self-vehicle trajectory vectorized features of the target vehicle.

Step S206: Select a second surrounding vehicle of the target vehicle based on the target vehicle.

In this implementation, the second surrounding vehicle of the target vehicle may be selected according to a second rule.

Step S207: Construct sequential data of the second surrounding vehicle.

In this implementation, a vehicle trajectory of the second surrounding vehicle may be subjected to sequential processing, and then converted to the coordinate system with the current frame position of the target vehicle as the origin, so as to obtain the sequential data of the second surrounding vehicle.

Step S208: Add semantic information to the sequential data of the second surrounding vehicle.

In this implementation, the semantic information may be added to the sequential data of the second surrounding vehicle.

Step S209: Obtain trajectory vectorized features of the second surrounding vehicle.

In this implementation, the sequential data with the semantic information added may be used as the surrounding trajectory vectorized features of the second surrounding vehicle.

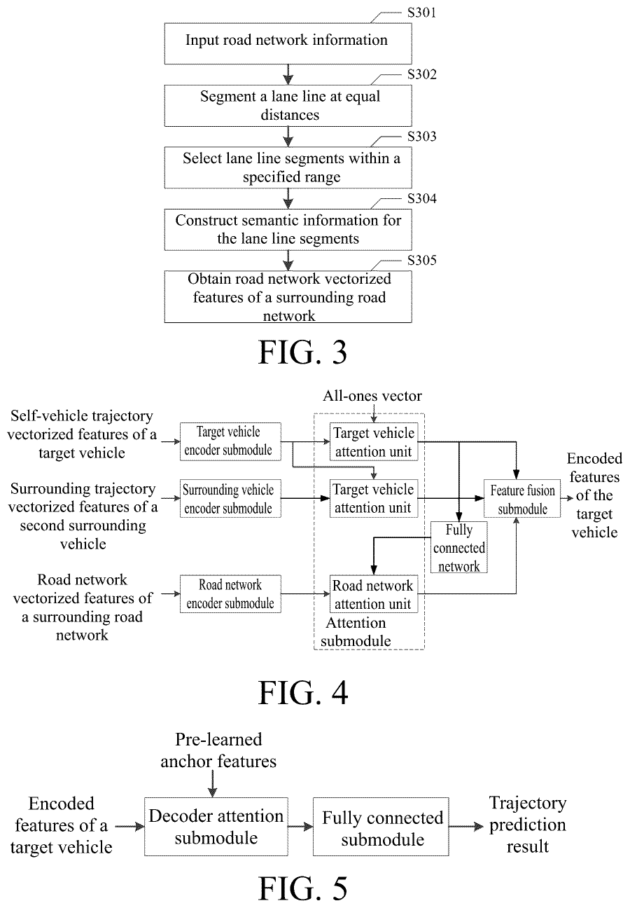

In an implementation, reference may be made to FIG. 3. FIG. 3 is a schematic flowchart of main steps of obtaining road network vectorized features of a target vehicle according to an implementation of an embodiment of the disclosure. As shown in FIG. 3, the road network vectorized features may be obtained through step S301 to step S305 as follows.

Step S301: Input road network information.

In this implementation, road network information obtained by a perception model may be input.

Step S302: Segment a lane line at equal distances.

In this implementation, the method described in step S302 is similar to the foregoing step S10113. For simplicity of description, details are not described herein again.

Step S303: Select lane line segments within a specified range.

In this implementation, the method described in step S303 is similar to the foregoing step S10115. For simplicity of description, details are not described herein again.

Step S304: Construct semantic information for the lane line segments.

In this implementation, the semantic information may be constructed for the lane line segments.

Step S305: Obtain road network vectorized features of a surrounding road network.

In this implementation, the semantic information may be added to the selected lane line segments to obtain the vectorized features of the road network.

It should be noted that, although the steps are described in a specific order in the above embodiments, those skilled in the art may understand that in order to implement the effects of the disclosure, different steps are not necessarily performed in such an order, but may be performed simultaneously (in parallel) or in other orders, and these changes shall all fall within the scope of protection of the disclosure.

It should be noted that data (including but not limited to data used for analysis, data stored, data displayed, vehicle usage data, data acquired by a vehicle, data sensed by a vehicle, etc.) involved in the embodiments of the present disclosure are all data fully authorized by all parties. Actions such as the obtaining of the perceived data, acquisition, and construction of the vectorized features involved in the embodiments of this disclosure are all performed with the authorization of the user and the object, or after being fully authorized by all parties, and are also processed in accordance with processing rules authorized by the user.

Those skilled in the art can understand that all or some of the procedures in the method of the foregoing embodiment of the disclosure may also be implemented by a computer program instructing relevant hardware. The computer program may be stored in a computer-readable storage medium, and when the computer program is executed by a processor, the steps of the foregoing method embodiments may be implemented. The computer program includes computer program codes, which may be in a source code form, an object code form, an executable file form, some intermediate forms, or the like. The computer-readable storage medium may include: any entity or apparatus that can carry the computer program code, a medium, a USB flash drive, a removable hard disk, a magnetic disk, an optical disc, a computer memory, a read-only memory, a random access memory, an electric carrier signal, a telecommunications signal, and a software distribution medium. It should be noted that the content included in the computer-readable storage medium may be appropriately added or deleted depending on requirements of the legislation and patent practice in a jurisdiction. For example, in some jurisdictions, according to the legislation and patent practice, the computer-readable storage medium does not include an electric carrier signal and a telecommunications signal.

Further, the disclosure further provides a control device. In a control device embodiment according to the disclosure, the control device includes a processor and a storage apparatus. The storage apparatus may be configured to store a program for performing the method for predicting a vehicle trajectory in the foregoing method embodiment. The processor may be configured to execute a program in the storage apparatus, where the program includes, but is not limited to, the program for performing the method for predicting a vehicle trajectory in the foregoing method embodiment. For ease of description, only parts related to the embodiment of the disclosure are shown. For specific technical details that are not disclosed, refer to the method part of the embodiments of the disclosure.

The control device in this embodiment of the disclosure may be a control device formed by various electronic devices. In some possible implementations, the control device may include a plurality of storage apparatuses and a plurality of processors. The program for performing the method for predicting a vehicle trajectory in the foregoing method embodiment may be divided into a plurality of subprograms, and each subprogram may be loaded and executed by the processor to perform different steps of the method for predicting a vehicle trajectory in the foregoing method embodiment. Specifically, each subprogram may be stored in a different storage apparatus, and each processor may be configured to execute programs in one or more storage apparatuses to jointly implement the method for predicting a vehicle trajectory in the foregoing method embodiment. In other words, each processor separately performs different steps of the method for predicting a vehicle trajectory in the foregoing method embodiment to jointly implement the method for predicting a vehicle trajectory in the foregoing method embodiment.

The plurality of processors may be processors deployed on a same device. For example, the foregoing control device may be a high-performance device including a plurality of processors, and the plurality of processors may be processors configured on the high-performance device. Alternatively, the plurality of processors may be processors deployed on different devices. For example, the foregoing control device may be a server cluster, and the plurality of processors may be processors on different servers in the server cluster.

Further, the disclosure further provides a computer-readable storage medium. In a computer-readable storage medium embodiment according to the disclosure, the computer-readable storage medium may be configured to store a program for performing the method for predicting a vehicle trajectory in the foregoing method embodiment, and the program may be loaded and executed by a processor to implement the foregoing method for predicting a vehicle trajectory. For ease of description, only parts related to the embodiment of the disclosure are shown. For specific technical details that are not disclosed, refer to the method part of the embodiments of the disclosure. The computer-readable storage medium may be a storage apparatus formed by various electronic devices. Optionally, the computer-readable storage medium in the embodiment of the disclosure is a non-transitory computer-readable storage medium.

Further, the disclosure further provides a vehicle. In a vehicle embodiment according to the disclosure, the vehicle may include the control device in the control device embodiment.

Further, it should be understood that, because the configuration of modules is merely intended to illustrate function units of the apparatus in the disclosure, physical devices corresponding to these modules may be a processor itself, or part of software, part of hardware, or part of a combination of software and hardware in the processor. Therefore, the number of modules in the figure is merely illustrative.

Those skilled in the art can understand that the modules in the apparatus may be adaptively split or merged. Such a split or combination of specific modules does not cause the technical solutions to depart from the principle of the disclosure. Therefore, technical solutions after any such split or combination shall all fall within the scope of protection of the disclosure.

Heretofore, the technical solutions of the disclosure have been described with reference to the preferred implementations shown in the accompanying drawings. However, those skilled in the art can readily understand that the scope of protection of the disclosure is apparently not limited to these specific implementations. Those skilled in the art may make equivalent changes or substitutions to the related technical features without departing from the principle of the disclosure, and all the technical solutions with such changes or substitutions shall fall within the scope of protection of the disclosure.

What is claimed is:

1. A method for predicting a vehicle trajectory, comprising:
obtaining vectorized features of a plurality of target vehicles based on perceived information of an autonomous vehicle; and
obtaining a trajectory prediction result based on vectorized features of each of the target vehicles, to obtain a plurality of trajectory prediction results of the plurality of target vehicles; wherein
the plurality of target vehicles comprise the autonomous vehicle and a plurality of first surrounding vehicles, wherein the plurality of first surrounding vehicles being vehicles in a surrounding environment of the autonomous vehicle that are selected according to a preset first rule; and
the perceived information is obtained based on data acquired by a sensor of the autonomous vehicle.

2. The method for predicting a vehicle trajectory of claim 1, wherein the obtaining vectorized features of a plurality of target vehicles further comprises:
obtaining, based on the perceived information of the autonomous vehicle, self-vehicle trajectory vectorized features, surrounding trajectory vectorized features, and road network vectorized features of each of the target vehicles; wherein
the surrounding trajectory vectorized features are trajectory vectorized features of a plurality of second surrounding vehicles of the target vehicle, the plurality of second surrounding vehicles being vehicles in a surrounding environment of the target vehicle that are selected according to a preset second rule.

3. The method for predicting a vehicle trajectory of claim 2, wherein the obtaining a trajectory prediction result based on vectorized features of each of the target vehicles further comprises:
obtaining, for each of the target vehicles, encoded features of the target vehicle based on the self-vehicle trajectory vectorized features, the surrounding trajectory vectorized features, and the road network vectorized features of the target vehicle; and
obtaining the trajectory prediction result of the target vehicle based on the encoded features of the target vehicle.

4. The method for predicting a vehicle trajectory of claim 3, wherein the obtaining encoded features of the target vehicle based on the self-vehicle trajectory vectorized features, the surrounding trajectory vectorized features, and the road network vectorized features of the target vehicle further comprises:
encoding the self-vehicle trajectory vectorized features, the surrounding trajectory vectorized features, and the road network vectorized features to obtain self-vehicle trajectory encoded features, surrounding trajectory encoded features, and road network encoded features, respectively;
performing feature interaction on the self-vehicle trajectory encoded features, the surrounding trajectory encoded features, and the road network encoded features to obtain self-vehicle trajectory interaction features, surrounding trajectory interaction features, and environment interaction features, respectively; and
performing feature fusion on the self-vehicle trajectory interaction features, the surrounding trajectory interaction features, and the environment interaction features to obtain the encoded features of the target vehicle.

5. The method for predicting a vehicle trajectory of claim 4, wherein the performing feature interaction on the self-vehicle trajectory encoded features, the surrounding trajectory encoded features, and the road network encoded features further comprises:
using, for the self-vehicle trajectory encoded features, an all-ones vector as environment information for feature interaction to obtain the self-vehicle trajectory interaction features;
using, for the surrounding trajectory encoded features, the self-vehicle trajectory encoded features as environment information for feature interaction to obtain the surrounding trajectory interaction features; and
using, for the road network encoded features, fusion features of the self-vehicle trajectory interaction features and the surrounding trajectory interaction features as environment information for feature interaction to obtain the road network interaction features.

6. The method for predicting a vehicle trajectory of claim 5, wherein the method for predicting a vehicle trajectory further comprises obtaining the fusion features of the self-vehicle trajectory interaction features and the surrounding trajectory interaction features according to the step of:
performing feature fusion on the self-vehicle trajectory interaction features and the surrounding trajectory interaction features to obtain the fusion features.

7. The method for predicting a vehicle trajectory of claim 3, wherein the obtaining the trajectory prediction result of the target vehicle based on the encoded features of the target vehicle comprises:
using pre-learned anchor features as environment information, and obtaining multimodal features of the target vehicle based on the encoded features of the target vehicle; and
obtaining the trajectory prediction result of the target vehicle based on the multimodal features.

8. The method for predicting a vehicle trajectory of claim 4, wherein the obtaining the trajectory prediction result of the target vehicle based on the encoded features of the target vehicle comprises:
using pre-learned anchor features as environment information, and obtaining multimodal features of the target vehicle based on the encoded features of the target vehicle; and
obtaining the trajectory prediction result of the target vehicle based on the multimodal features.

9. The method for predicting a vehicle trajectory of claim 1, wherein the obtaining vectorized features of a plurality of target vehicles based on perceived information of an autonomous vehicle comprises:
for each target vehicle, structuring the perceived information to obtain structured data of the target vehicle; and
adding semantic information to the structured data to obtain vectorized features of the target vehicle.

10. The method for predicting a vehicle trajectory of claim 2, wherein the obtaining vectorized features of a plurality of target vehicles based on perceived information of an autonomous vehicle comprises:
for each target vehicle, structuring the perceived information to obtain structured data of the target vehicle; and
adding semantic information to the structured data to obtain vectorized features of the target vehicle.

11. The method for predicting a vehicle trajectory of claim 9, wherein for each target vehicle, as well as a vehicle trajectory of the target vehicle and vehicle trajectories of the plurality of second surrounding vehicles of the target vehicle in the perceived information, the structuring the perceived information comprises:
performing sequential processing on the vehicle trajectory of the target vehicle and the vehicle trajectory of each of the second surrounding vehicles to obtain sequential data comprising a historical frame and a current frame of a preset length; and
converting the sequential data into a coordinate system with a current frame position of the target vehicle as an origin so that the sequential data is used as the structured data of the target vehicle.

12. The method for predicting a vehicle trajectory of claim 9, wherein for each target vehicle, as well as road network information of a surrounding road network of the target vehicle in the perceived information, the structuring the perceived information comprises:
segmenting a lane line in the road network information according to a preset distance to obtain a plurality of lane line segments;
converting endpoint coordinates of the lane line segments to the coordinate system with the current frame position of the target vehicle as the origin;
for the lane line segments in the coordinate system with the current frame position of the target vehicle as the origin, selecting from the lane line segments according to a preset third rule; and
using endpoint coordinates of the selected lane line segments as the structured data of the target vehicle.

13. A control device, comprising at least one processor and at least one storage apparatus storing a plurality of program codes, wherein the program codes are adapted to be loaded and executed by the processor to perform the method for predicting a vehicle trajectory, wherein the method for predicting a vehicle trajectory comprises:
obtaining vectorized features of a plurality of target vehicles based on perceived information of an autonomous vehicle; and
obtaining a trajectory prediction result based on vectorized features of each of the target vehicles, to obtain a plurality of trajectory prediction results of the plurality of target vehicles; wherein
the plurality of target vehicles comprise the autonomous vehicle and a plurality of first surrounding vehicles, wherein the plurality of first surrounding vehicles being vehicles in a surrounding environment of the autonomous vehicle that are selected according to a preset first rule; and
the perceived information is obtained based on data acquired by a sensor of the autonomous vehicle.

14. The control device of claim 13, wherein the obtaining vectorized features of a plurality of target vehicles further comprises:
obtaining, based on the perceived information of the autonomous vehicle, self-vehicle trajectory vectorized features, surrounding trajectory vectorized features, and road network vectorized features of each of the target vehicles; wherein
the surrounding trajectory vectorized features are trajectory vectorized features of a plurality of second surrounding vehicles of the target vehicle, the plurality of second surrounding vehicles being vehicles in a surrounding environment of the target vehicle that are selected according to a preset second rule.

15. The control device of claim 14, wherein the obtaining a trajectory prediction result based on vectorized features of each of the target vehicles further comprises:
obtaining, for each of the target vehicles, encoded features of the target vehicle based on the self-vehicle trajectory vectorized features, the surrounding trajectory vectorized features, and the road network vectorized features of the target vehicle; and
obtaining the trajectory prediction result of the target vehicle based on the encoded features of the target vehicle.

16. The control device of claim 15, wherein the obtaining encoded features of the target vehicle based on the self-vehicle trajectory vectorized features, the surrounding trajectory vectorized features, and the road network vectorized features of the target vehicle further comprises:
encoding the self-vehicle trajectory vectorized features, the surrounding trajectory vectorized features, and the road network vectorized features to obtain self-vehicle trajectory encoded features, surrounding trajectory encoded features, and road network encoded features, respectively;
performing feature interaction on the self-vehicle trajectory encoded features, the surrounding trajectory encoded features, and the road network encoded features to obtain self-vehicle trajectory interaction features, surrounding trajectory interaction features, and environment interaction features, respectively; and
performing feature fusion on the self-vehicle trajectory interaction features, the surrounding trajectory interaction features, and the environment interaction features to obtain the encoded features of the target vehicle.

17. The control device of claim 16, wherein the performing feature interaction on the self-vehicle trajectory encoded features, the surrounding trajectory encoded features, and the road network encoded features further comprises:
using, for the self-vehicle trajectory encoded features, an all-ones vector as environment information for feature interaction to obtain the self-vehicle trajectory interaction features;
using, for the surrounding trajectory encoded features, the self-vehicle trajectory encoded features as environment information for feature interaction to obtain the surrounding trajectory interaction features; and
using, for the road network encoded features, fusion features of the self-vehicle trajectory interaction features and the surrounding trajectory interaction features as environment information for feature interaction to obtain the road network interaction features.

18. The control device of claim 17, wherein the method for predicting a vehicle trajectory further comprises obtaining the fusion features of the self-vehicle trajectory interaction features and the surrounding trajectory interaction features according to the step of:
performing feature fusion on the self-vehicle trajectory interaction features and the surrounding trajectory interaction features to obtain the fusion features.

19. The control device of claim 15, wherein the obtaining the trajectory prediction result of the target vehicle based on the encoded features of the target vehicle comprises:
using pre-learned anchor features as environment information, and obtaining multimodal features of the target vehicle based on the encoded features of the target vehicle; and
obtaining the trajectory prediction result of the target vehicle based on the multimodal features.

20. A vehicle, comprising the control device of claim 13.
